(19) United States
(12) Patent Application Publication
(10) Pub. No.: US 2016/0247383 A1
(43) Pub. Date: Aug. 25, 2016

(54) METHODS FOR DELIVERING EMERGENCY ALERTS TO VIEWERS OF VIDEO CONTENT DELIVERED OVER IP NETWORKS AND TO VARIOUS DEVICES

(71) Applicant: MOBILAPS, LLC, Silver Spring, MD (US)

(72) Inventor: Hisham KASSAB, Silver Spring, MD (US)

(21) Appl. No.: 14/769,650

(22) PCT Filed: Feb. 21, 2014
(86) PCT No.: PCT/IB2014/000907

§ 371 Date: Aug. 21, 2015

Related U.S. Application Data
(60) Provisional application No. 61/850,710, filed on Feb. 21, 2013.
(60) Provisional application No. 61/922,088, filed on Dec. 30, 2013.

(51) Int. Cl. G08B 27/00; H04N 21/81

(52) U.S. Cl. CPC G08B 27/008; H04N 21/814; H04L 67/02

(57) ABSTRACT

Apparatuses and techniques are described for delivering mass notification messages to electronic devices and multimedia applications with the possibility of enhancing the mass notification messages. Apparatuses and techniques are described for delivering emergency alerts to personal electronic devices. Techniques are describes for delivering emergency alerts to video applications receiving video content over IP networks. Apparatuses and techniques above can be extended to other types of mass notification message such as advertisement messages.

### CLAIM OF PRIORITY

This patent application claims priority to and benefit of the filing date of U.S. Provisional Patent Application Ser. No. 61/850,710, filed Feb. 21, 2013, and entitled “METHODS FOR DELIVERING EMERGENCY ALERTS TO VIEWERS OF VIDEO CONTENT DELIVERED OVER IP NETWORKS AND TO VARIOUS DEVICES,” and of U.S. Provisional Patent Application Ser. No. 61/922,088, filed May 23, 2012, and entitled “METHODS FOR ENHANCING GEOTARGETING AND OTHER FEATURES OF WEA/WEA,” the entire contents of both of which are hereby expressly incorporated by reference.

### CROSS-REFERENCE TO RELATED APPLICATIONS

None

### FIELD OF THE INVENTION

The invention generally relates to the field of mass notifications, and more specifically to techniques for delivering mass notifications to electronic devices and multimedia applications with the possibility of enhancing a notification after it has been received.

### BACKGROUND

Electronic devices and software applications are playing an increasingly important role in many aspects of a person's life. One important class of software applications is the class of multimedia applications, and in particular multimedia applications with the capability of rendering video content. It may be desired to transmit mass notifications to electronic devices and software applications. Mass notification refers to the one-way dissemination of messages containing information to one or many groups of recipients. A group of recipients may consist of one or more recipients. Examples of mass notifications include advertisement notifications and emergency notifications. In the example of an emergency notification, it may be desired to alert the human user of an electronic device of an imminent threat and to provide information about the nature of the imminent threat and how to respond to the imminent threat e.g., “seek shelter”.

Some electronic devices are natively equipped to receive certain mass notifications. For example, a modern cellular device, such as a cellular telephone or a tablet with cellular connectivity, may be natively equipped to receive Wireless Emergency Alerts (WEAs) (also known as CMAS alerts and PWS alerts) broadcast by a cellular base-station (henceforth referred as a base-station). WEAs are a type of emergency notifications. Some electronic devices may not be natively equipped to receive certain mass notifications. For example, although a video gaming console might have an Internet connection, it may not be natively equipped to receive emergency notifications. Similarly, it may be desired for a multimedia application on a cellular device to display mass notifications within the content rendered by the said multimedia application. For example, it may desired for a video player application on a cellular device to render an emergency alert in manner similar to an emergency alert rendered within TV programming via the Emergency Alert System (EAS).

It may be desired to enhance the mass notification message after it is originated. There are several forms of enhancement, including information enrichment, customization and geo-filtering. For information enrichment, new information may be added to the mass notification message. For customization, the content of a mass notification message may be customized to the individual recipient. For example, an emergency notification message may be customized to provide a customized evacuation route for the individual recipient. For geo-filtering, the rendering of the mass notification message to the recipient may be blocked based on the geographic location of the recipient. For example, in the case of WEA emergency notification, it is possible for cellular device to be within a group receiving a WEA emergency notification, even though the cellular device is not in the geographic area intended to receive the WEA emergency notification, as determined by the originator of the WEA emergency notification. The WEA emergency notification may be enhanced by determining that the recipient is outside the said geographic area and subsequently be blocked from being rendered to the said recipient.

### SUMMARY

The limitations of the art are alleviated to a great extent by the methods for delivering mass notification messages to electronic devices and multimedia applications.

The following presents a simplified summary of the present invention to provide a basic understanding of some of its aspects. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

Apparatuses and techniques are described for delivering mass notification messages to electronic devices and multimedia applications with the possibility of enhancing the mass notification messages. Apparatuses and techniques are described for delivering emergency alerts to personal electronic devices. Techniques are describes for delivering emergency alerts to video applications receiving video content over IP networks. Apparatuses and techniques above can be extended to other types of mass notification message such as advertisement messages.

### BRIEF DESCRIPTION OF DRAWINGS

The foregoing features, as well as other features, will become apparent with reference to the description and figures below, in which like numerals represent elements and in which:

FIG. 1 is a prior art schematic diagram illustrating how a client and server may be connected via the Internet;

FIG. 2 is a prior art schematic diagram illustrates the passage of Internet traffic between one or more proxy servers before flowing through the Internet;

FIG. 3 shows a high-level flowchart illustrating the manner in which a recipient of an MNM may enhance the MNM;

FIG. 4A shows a high-level architecture of how electronic devices may be enabled to receive MNMs;

FIG. 4B shows a high-level architecture of how applications may be enabled to receive MNMs;

FIG. 4C shows a high-level architecture of how applications may be enabled to receive MNMs;

FIG. 5 shows an example of how a personal electronic device may be enabled to display emergency alert messages based on WEA Broadcast messages;

FIG. 6 shows a high-level flowchart illustrating how WEA messages may be enhanced on cellular devices, with the example of enhancement being improving the precision of geo-targeting; and

FIG. 7 illustrates an exemplary computer system which may be used in some implementations.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein are for the purpose of description and should not be regarded as limiting. The use of “including,” “comprising,” or “having” and variations thereof herein are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments of the invention may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects of the invention may be implemented in software (e.g., stored on non-transitory computer-readable medium). As such, it should be noted that a plurality of hardware and software based devices, as well as a plurality of different structural components may be utilized to implement the invention. Furthermore, and as described in subsequent paragraphs, the specific mechanical configurations illustrated in the drawings are intended to exemplify embodiments of the invention and that other alternative mechanical configurations are possible.

Applicant has recognized and appreciated that the utility of electronic devices and multimedia applications on general purpose computing devices may be significantly improved by techniques for enabling the said electronic devices to receive mass notification messages, and to possibly enhance a received mass notification message beyond the originated version.

### Intermediate Network Entity

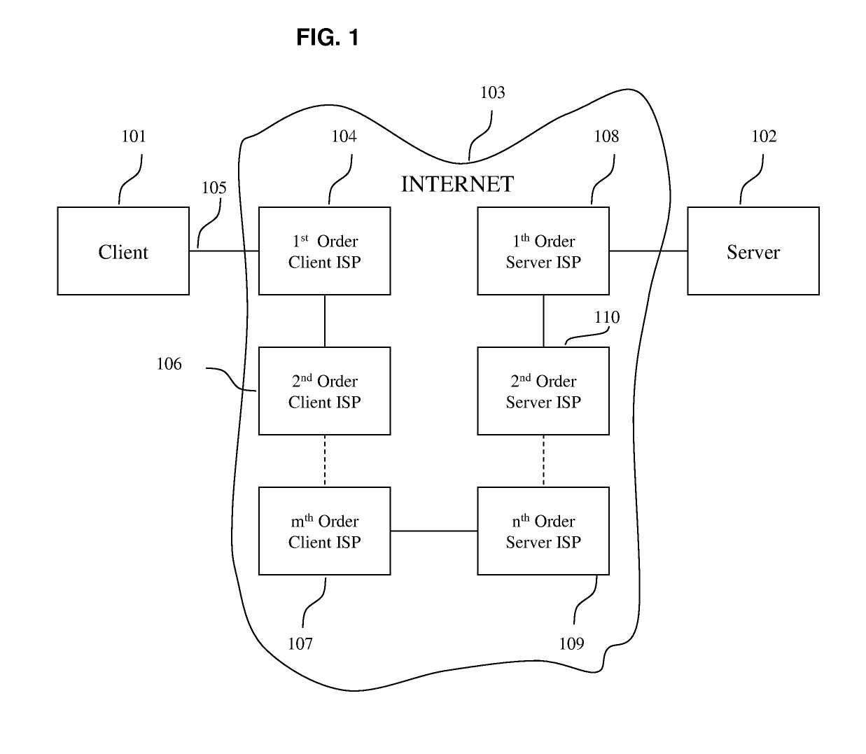

FIG. 1 illustrates how a client 101 and server 102 may be connected via the Internet 103. The client typically has an Internet Service Provider (ISP), such as first-order ISP 104. The client 101 connects to 104 via path 105 which may be any of several types of connection including dial-up, DSL, cable modem, fixed wireless, Wi-Fi, and cellular. First-order ISP 104 may have its own ISP, 106, which in turn may have its own ISP and so on. FIG. 1 depicts a hierarchy of m ISP's on the client side. A similar structure exists on the server side, where the server has an ISP 108, which itself is part of a chain of ISP's that goes up to an nth ISP 109, which connects with the mth ISP on the client side. (The mth client ISP and the nth server ISP may be the same ISP.) The point of FIG. 1 is that Internet traffic/data exchanged between a client 101 and a server 102 typically passes through the gateways (also known as edge routers) of several Internet Service Providers.

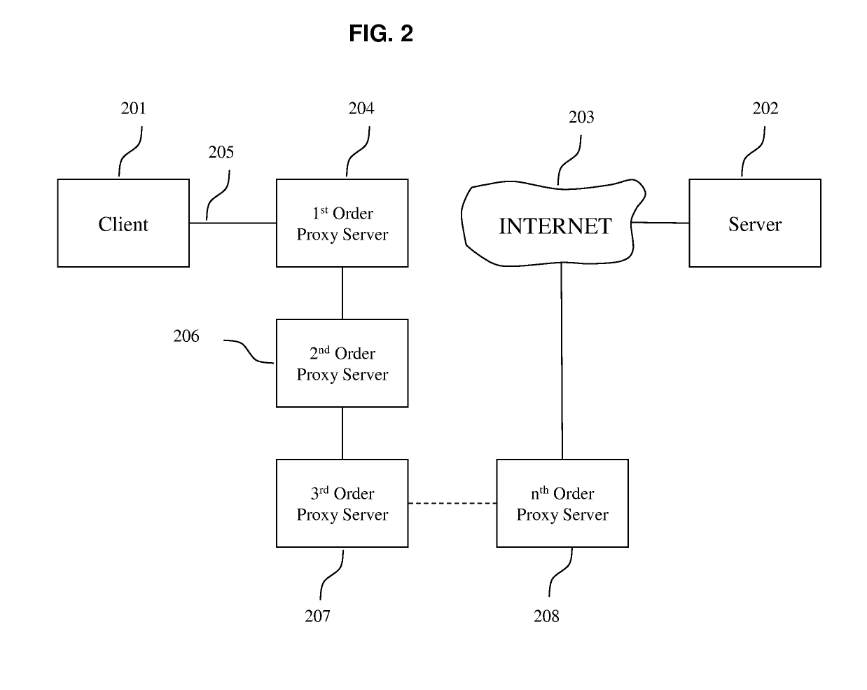

FIG. 2 shows that Internet traffic between a client 201 and a server 202 may pass through one or more proxy servers 204 before flowing through the Internet 203. A proxy server “hears” and services requests from its clients, often re-initiating requests on behalf of its clients and passing the corresponding responses to the clients. A client may explicitly redirect traffic to the proxy server, or the traffic may be redirected without the explicit specification of the client. The connection between the client and the proxy server 205 may take several forms, including a point-to-point connection, a connection over a local area network, or a connection over the Internet. Also, as with the hierarchy of ISP's, it is possible to have a hierarchy of proxy servers 206, 207 and 208 as shown in FIG. 2.

FIG. 1 and FIG. 2 illustrate that there may be several entities on the path between a client and a server. This can be true even if the client and the server are on the same local area network or wide area network (i.e., not connected over the Internet). For purposes of this application, any such entity on the path between a client and a server will be referred to as an “intermediate network entity” (INE). By virtue of being physically in the path between the client and the server, an INE potentially can modify the client's request message before it reaches the server, as well as the server's response message before it reaches the client. An INE may comprise a proxy server; an ISP; or a VPN device, for example.

### Enhancement of Mass Notification Messages

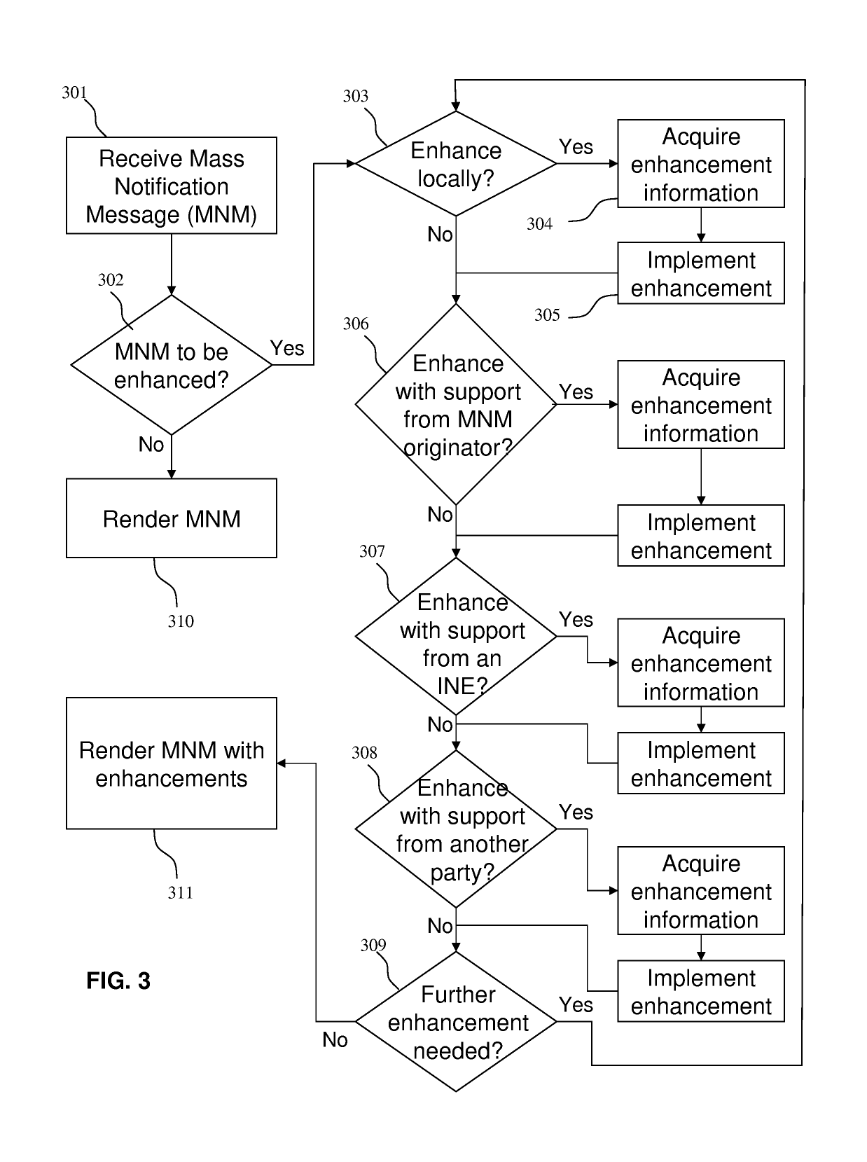

FIG. 3 illustrates one technique for the enhancement of a Mass Notification Message after it has been originated. The MNM may be received by a recipient. Examples of a recipient include: an electronic device and an application running on a general purpose computing device (GPC device), such as a multimedia application. Upon the receipt of the MNM by the recipient 301, the recipient may determine whether to enhance the MNM 302. If the determination is to enhance the MNM, the recipient may have several options for enhancing the MNM. For example, the recipient may determine whether to enhance the MNM using locally available resources 303. If the determination is to implement an enhancement locally, the recipient may acquire enhancement information that is available locally within the device. The recipient may then implement the enhancement to the MNM. Similarly, the recipient may determine whether to enhance the MNM based on support from other entities including the originator of the MNM 306, an INE 307, or another party 308. In each case, the recipient may acquire the enhancement information from an entity and implement the enhancement. Upon completing one iteration through the determinations 303, 306, 307, 308, the recipient may determine whether to go through another iteration of determinations 309. In each iteration, the determinations 303, 306, 307, 308 may be in a different order than the one shown in FIG. 3. The recipient may also skip one or more determinations in an iteration. If the recipient does not elect to enhance the received MNM, it may render it without enhancement 310. If the recipient does elect to enhance the MNM, it may render it with enhancements 311.

### Enabling Devices and Applications to Receive MNMs

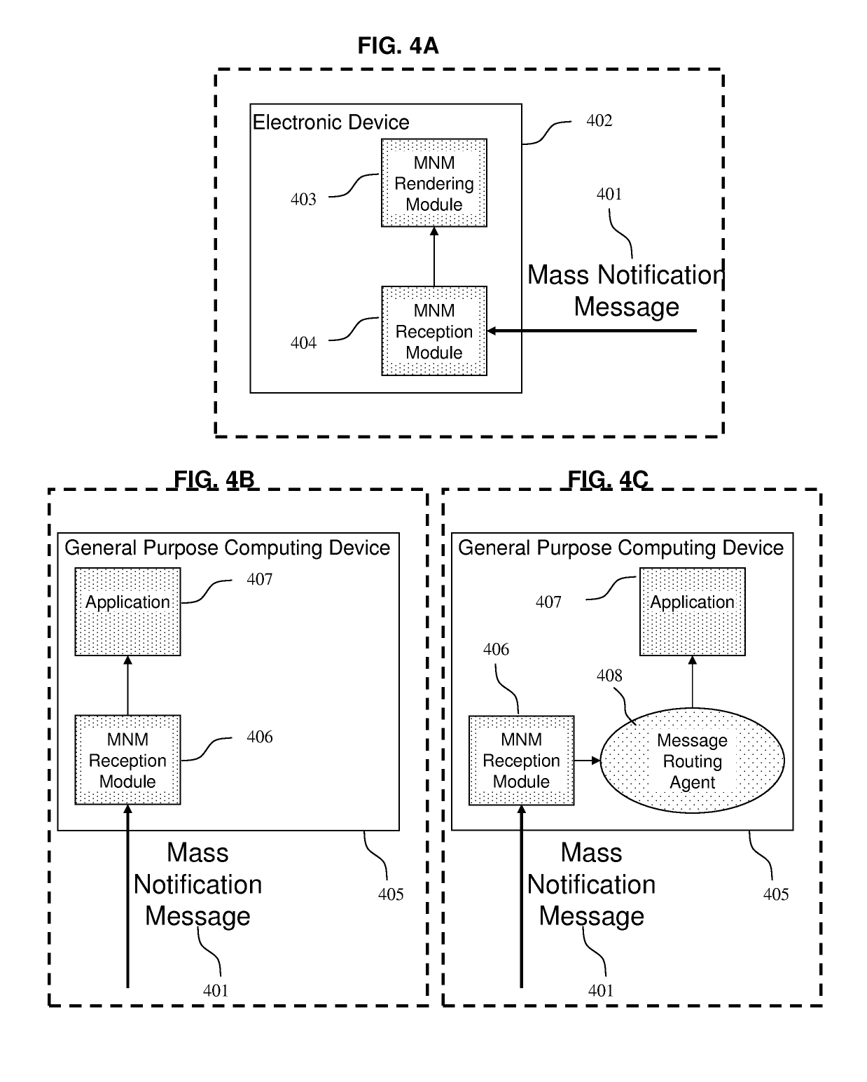

An electronic device or an application may not be natively designed to be capable of receiving one or more types of MNMs. One type of MNMs in the United States is WEA messages. Personal electronic devices such as desktop computers, video gaming systems and smoke detectors are not natively designed to receive WEA messages. FIG. 4A illustrates the enablement of an electronic device 402 to receive one or more types of MNMs. The enablement may entail adding an MNM reception module 404, whose role may be to receive one or more types of MNMs. The MNM reception module may pass a received MNM to an MNM rendering module 403, which may render the MNM in manner that is suited for the electronic device, possibly after the MNM is enhanced. 403 and 404 may be added to the device in an integrated fashion or as an accessory component. One or more MNM reception modules may be included in an electronic device. One of more MNM rendering modules may be included in an electronic device. FIG. 4B illustrates a general purpose computing device 405 that may be equipped with an MNM Reception Module 406. For example, modern cellular devices are equipped with WEA message receivers. However, an application on 406 may not be originally able to access MNMs received by 406. This limited access may be addressed by explicitly sending a received MNM from 406 to 407. Alternatively, as shown in FIG. 4C, a Message Routing Agent 408 maybe introduced to 405, with the role of acquiring the MNM from 406 and availing the MNM to one or more applications 407. Applications that have access to one or more types of MNMs may need to be given explicit privileges. Upon receipt of an MNM, an application may render the MNM in a manner suited for the said application. For example, a multimedia application may render a received MNM within the multimedia content rendered by the multimedia application. Therefore, a video application may render the MNM within the video content it displays.

### Enabling Electronic Devices to Receive WEA Messages

Emergency notification is an important operation in the overall emergency preparedness of a community. In the United States, the Emergency Alert System (EAS) has historically been effective in disseminating alerts to the public. However, there has been a gradual erosion of the effectiveness of TV/Radio alerting, as the US public increasingly cuts the cord and gets its infotainment from a plethora of personal electronic devices, including video gaming devices, DVRs, eReaders, and MP3 players. The fragmentation of infotainment electronic devices is aggravated by fragmentation within each category of electronic devices.

One complicated solution would be to develop, test, and deploy a separate alerting technology for each category/sub-category of electronic devices—present and future.

A more efficient solution is based on WEA. Since WEA messages are broadcast, any electronic device may receive the WEA message. This is very similar to GPS, where the signal(s) is (are) broadcast to all to receive, and like GPS, the WEA reception module hardware has been miniaturized to such a point, that it can be housed in almost any electronic device. Each electronic device may then render the WEA message to the owner/user in manner that is suited for the electronic device.

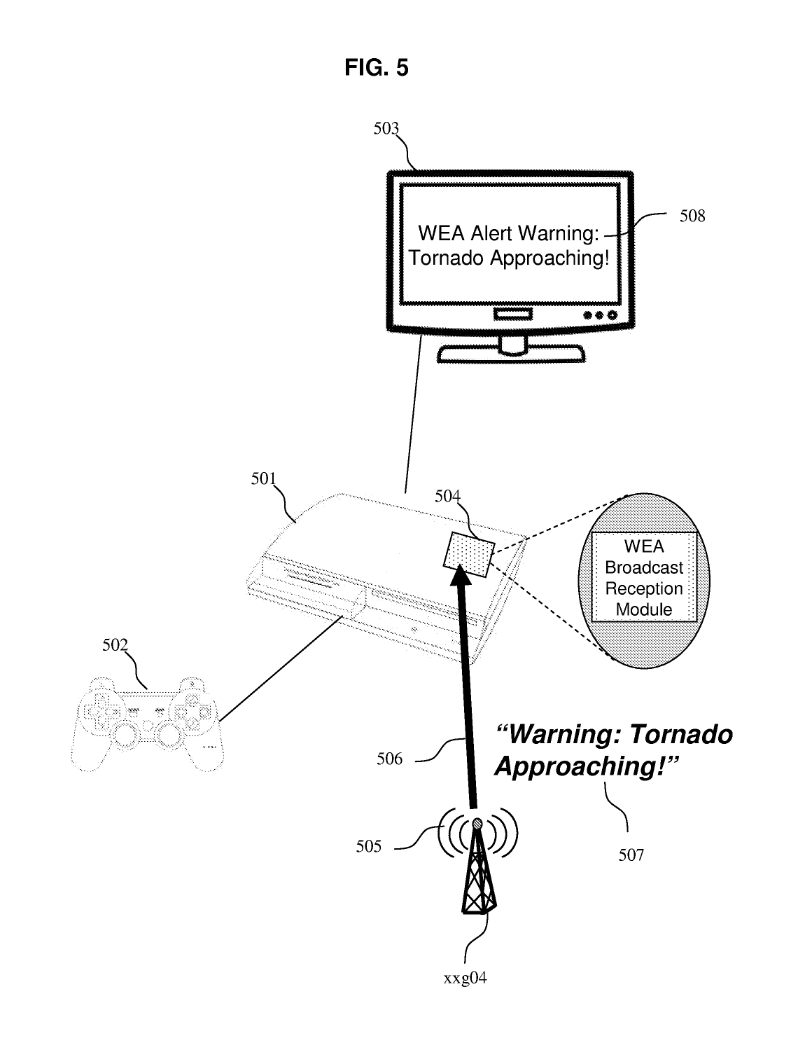

FIG. 5 illustrates the enablement of a video gaming system to render emergency notification messages based on the receipt of a WEA alert. The video gaming system may consist of a video gaming console 501 and a video gaming controller 502. 501 may be equipped with a WEA Broadcast Reception Module. The WEA Broadcast Reception Module may be a cellular receiver that is typically included in cellular phones. Upon the receipt of a WEA message from a base-station, 504 may pass the message to a WEA rendering module in 501, which then causes the message to be displayed on a connected TV via the video output of 501. 501 may enhance the WEA message by using locally stored information or acquiring external information via a possible Internet connection.

Another example of an electronic device is a Satellite set top box. It may be equipped with a WEA Broadcast Reception Module, and the Satellite set top box may render the WEA message, or an enhanced version thereof, on the TV screen as part of the video content it feeds the TV. Another example of an electronic device is a Satellite radio receiver. Equipping it with a WEA Broadcast Reception Module, the Satellite radio receiver may employ text-to-speech technology to render the WEA message, or an enhanced version thereof, in an audio format. Another example of an electronic device is a personal computer. Equipping it with a WEA Broadcast Reception Module, the personal computer may splash the WEA message, or an enhanced version thereof, on the monitor. Another example of an electronic device is a smart thermostat. Equipping it with a WEA Broadcast Reception Module, the smart thermostat may splash the WEA message, or an enhanced version thereof, on its display. Another example of electronic device is a smoke detector. Equipping it with a WEA Broadcast Reception Module, the personal computer may render the WEA message in a siren-like fashion. Another example of an electronic device custom-designed to disseminate alerts. Equipping it with a WEA Broadcast Reception Module, the personal computer may render the WEA message.

In general, a WEA Broadcast Reception Module need not be a subscriber with the cellular provider operating the base-station. In some cellular networks, a WEA Broadcast Reception Module need not be known or announced to the base-station. It may simply acquire the WEA message from the broadcast system. In other cellular networks, a WEA Broadcast Reception Module may need to announce itself to the base-station with a valid primary cellular provider ID. One or more primary cellular provider IDs may be reserved for use by electronic devices for the purpose of correctly receiving WEA messages.

It can be appreciated that the techniques and apparatus described to enable electronic devices to render emergency notification messages based on WEA Broadcast messages can be extended to rendering advertisement notification messages based on cellular broadcast advertisement messages.

### Enhancing WEA Broadcast Messages on Cellular Devices

Upon receiving a WEA message, a cellular device receiving device may enhance the WEA message in at least one of several ways. Examples of such ways include: deciding whether or not to display/render/present the WEA alert message based on at least one of several factors—examples of such factors include: whether or not the device is located in the alert area, and whether or not the WEA alert message is of interest to the receiving device's user; displaying/rendering/presenting the WEA alert message with additional content related to the WEA alert—examples of additional content include: a photograph, a video, and a longer message; and displaying/rendering/presenting a processed version of the WEA alert—examples of processing include: translating the message into one or more other languages; and using natural language processing to extract relevant information from the message. The receiving device may enhance the WEA alert based on at least one type of information. Examples of such types include: locally stored information; information in the overhead of the WEA alert; Global Positioning System (GPS) signals; information that the receiving device may acquire from its physical surroundings; information that the receiving device may acquire from neighboring devices; information that the receiving device may acquire from a data network it is connected to information in a general cellular broadcast message; information in an MBMS (cellular Multimedia Broadcast Multicast Services) alert message; information in a general MBMS broadcast message; information in an M-EAS (Mobile Emergency Alert System) emergency alert message delivered via mobile digital TV broadcasting; information in a general mobile digital TV broadcast message; information in a NOAA Weather Radio All Hazards emergency alert message; information in a TV/Radio broadcast emergency alert message; information in a general TV/Radio broadcast message; and information communicated to the receiving device from at least one of several information providers. Examples of such information providers include: the Integrated Public Alert and Warning System Open Platform for Emergency Networks (IPAWS-OPEN); Google Public Alerts; an information server controlled by the device's ISP; a proxy server serving the device; and an end server serving the device. The said information provider or information providers may communicate a message to the client device using at least one of several communication means. Examples of such communication means include: using a wireless communication means; and communicating information over the Internet; wherein the receiving device may use at least one of several methods to connect to the Internet. Examples of such methods include: cellular connection; paging network connection; WiFi connection; WiMax connection; Bluetooth connection; and a wired connection.

Information communicated to the receiving device may include at least one of several categories of information. Examples of such categories include: a Common Alerting Protocol (CAP) message related to the received WEA alert message; geo-coordinates related to the received WEA alert message; one or more pictures related to the received WEA alert message; one of more videos related to the received WEA alert message; one or more audio recordings related to the received WEA alert message; and text related to the received WEA alert message. Information communicated to the receiving device from one or more information providers may be transmitted using at least one of several communication methods. Examples of such communication methods include: one or more responses from one or more information providers in response to one or more requests from the device; a local area network broadcast; and an IP multicast.

One example of the invention is as follows: Upon a mobile device, equipped with WiFi and GPS capabilities, receiving a WEA alert, one possibility would be to allow the mobile device to use only WiFi connectivity (if available) to fetch the geo-coordinates for the alert (e.g., by using the alert id) from a trusted server, and render the WEA alert only if the device is located within the polygon. If WiFi is not available to the device, then you do no worse than what we have today. And this way you won't congest the cellular network.

The technical concept in the example above is based on using the mobile device's WiFi and GPS capabilities. The WiFi capability would be used to fetch the precise geo-coordinates for the alert from a trusted server. This circumvents the option of downloading that data over 3G/4G, which cellular carriers are adamantly opposed to. The GPS capability will be used to acquire the location of the mobile device.

At a high level, upon receiving a WEA message, if it can be determined that the mobile device is not located within the alert area (based on the GPS coordinates and the alert's precise geo-coordinates), then the WEA alert is not displayed/rendered to the mobile device's user. Otherwise the alert would be displayed.

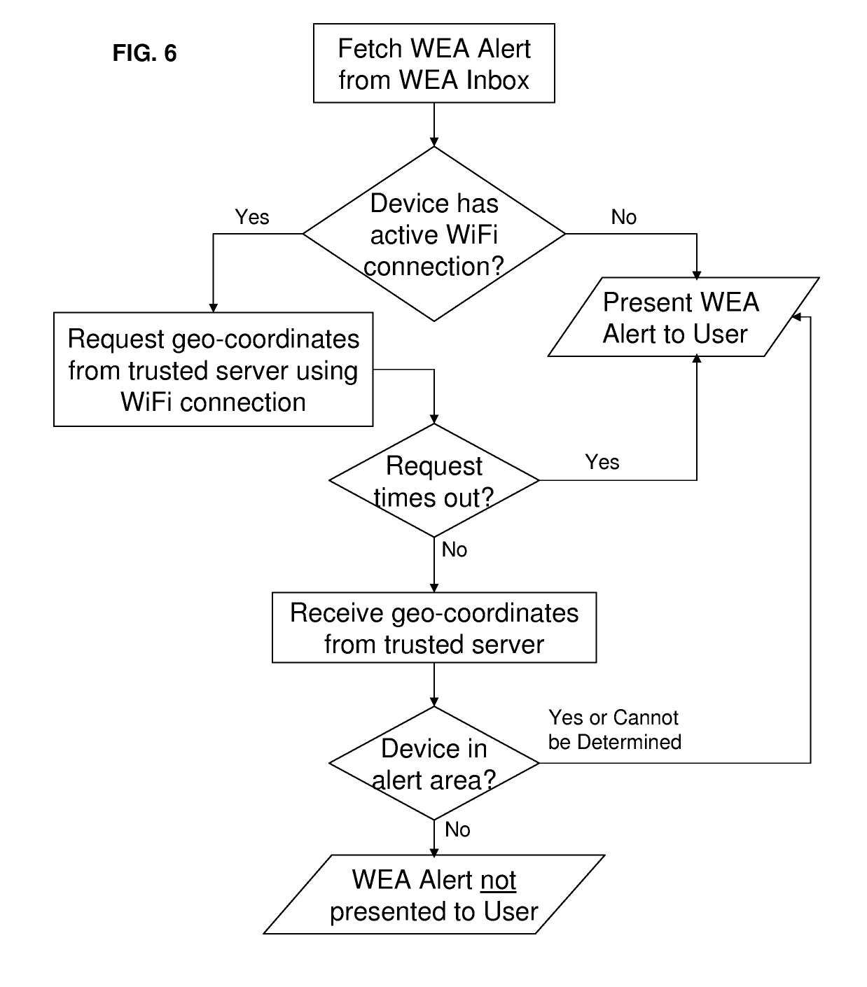

The invention may be implemented in the form of enhancing the WEA App (the application responsible for fetching the WEA message from the WEA Broadcast Reception Module and rendering it to the user) on the mobile device. FIG. 6 illustrates a flowchart for the enhanced WEA App.

The example above has a key step of downloading the alert's polygonal geo-coordinates from a trusted server. That trusted server can be the IPAWS OPEN gateway itself. However, that option is undesirable since it one does not want to overwhelm that gateway lest it is brought down, thus completely paralyzing WEA. Another option is the already operational Google Public Alerts gateway, which is more likely to be more reliable, scalable and secure. Mobile devices that do not incorporate the proposed enhancement to the WEA App, will simply render/present WEA alert messages as they do today. The example above can be extended to acquire other types of information that would enhance a WEA alert. It can be used to acquire a longer version of the alert message, that can then be displayed in lieu of or in conjunction with the original ninety-character WEA message. In the case of amber alerts, the additionally acquired information may include a photograph of the missing child and/or any suspects, that would enhance the public's ability to assist.

It can be appreciated that invention described for enhancing WEA alerts can be extended to be used for enhancing other forms of wireless broadcasts. In particular, the invention may be extended to advertising; whereby one or more advertisements may be wirelessly broadcast to devices. In the case of extending the invention to advertising, the description above may be modified as follows to make it more applicable to advertising: The term “WEA alert” may be substituted with the term “advertisement”. The term “alert area” may be substituted with the term “advertisement area”, whereby advertisement area refers to the geographic area to which the advertisement is targeted. The term “alert information” may be substituted with the term “advertisement information”, whereby advertisement information refers to information related to the advertisement. The term “WEA alert message” may be substituted with the term “advertisement message”. The term “emergency event” may be substituted with the term “advertised product”, whereby advertised product refers to the object of the advertisement such as a product, a service, an event, a TV event, a TV program, a campaign message, a public service announcement, or a request for help. The following types of information may be unlikely to be used: a WEA alert message; an MBMS alert message; an M-EAS emergency alert message delivered via mobile digital TV broadcasting; a NOAA Weather Radio All Hazards emergency alert message; and a TV/Radio broadcast emergency alert message. The following information providers may be unlikely to be used: the Integrated Public Alert and Warning System Open Platform for Emergency Networks (IPAWS-OPEN); and Google Public Alerts.

### Evolution of Video Content Delivered Over IP Networks

Watching video online or on-the-go on a tablet or mobile phone is no longer a novelty, nor is streaming Internet-delivered content to the TV in the living room. Driven by the boom in video-enabled devices, including PCs, smartphones, and IP-enabled set-top boxes and IP-enabled televisions, consumers have rapidly moved through the early-adopter phase of “TV Everywhere” to the stage where there is a growing mass of consumers who expect that any media should be available on any device over any network connection, delivered at the same high quality they have come to expect from traditional television services. There are predominantly three types of video delivered over Internet Protocol (IP) networks: live video; time-shifted video, including catch-up TV (replays a TV show that was broadcast hours or days ago), and start-over TV (replays the current TV show from its beginning); and Video-on-Demand (VOD) i.e., pre-recorded video selected via browsing a catalogue of videos.

The acronym IPTV stands for Internet Protocol Television. There is no universally-agreed-upon definition of IPTV; and historically, many different definitions of IPTV have appeared, including: elementary streams over IP networks, transport streams over IP networks, and a number of proprietary systems. However, one official definition approved by the International Telecommunication Union (ITU) focus group on IPTV (ITU-T FG IPTV) is as follows: “IPTV is defined as multimedia services such as television/video/audio/text/graphics/data delivered over IP-based networks managed to provide the required level of quality of service and experience, security, interactivity and reliability.” Although there is no universally-agreed-upon definition of IPTV, as implied by the ITU definition above, it is commonly understood that IPTV refers to the delivery of television services using the Internet protocol (IP) suite over a packet-switched network such as the Internet, as opposed to being delivered through traditional terrestrial, satellite signal, and cable television formats. Furthermore, when people discuss IPTV there are usually several implicit assumptions, including: (a) IPTV needs customer-premises-equipment/subscriber-premises-equipment (henceforth referred to as CPE) such as a set-top box (STB) that is typically connected to a television set, and converts IP data traffic into content in a form that can then be displayed on the television screen or other display device, however personal computers, tablets and other mobile devices capable of displaying video are not excluded from being considered as delivering true IPTV, as they can operate in the same way as an STB; (b) IPTV entails watching traditional TV channels with viewers demanding (and receiving) a smooth, high-resolution, lag-free picture; and (c) the IPTV television services are delivered over a managed/closed network, which allows tight end-to-end management/control of network security and performance, so for example the quality of service (QoS) can be controlled through network management, bandwidth provisioning, routing management, failover paths and a variety of other QoS practices.

In contrast, the term Internet TV is often used to refer to the delivery of television content over the public Internet, where the lack of end-to-end management/control implies no quality-of-service guarantee. When people discuss Internet TV there are usually several implicit assumptions, including: (a) Internet TV entails watching both user-generated content and television-style programming; (b) one group of Internet TV providers is traditional media companies that deliver some or all of their television programming (e.g., episodes of popular television shows and sporting events) to viewers over the public Internet; (c) another group of Internet TV providers includes video content aggregators that provide video content from multiple traditional media companies over the public Internet; and (d) Internet TV delivers a picture of reduced quality, which is tolerated by Internet TV viewers.

Several factors have contributed to blurring the lines between IPTV and Internet TV, including: (a) several providers of video content over the public Internet provide CPE, such as STBs through which Internet TV can be viewed on a television set; (b) increasing Broadband speeds and better video compressions techniques have enabled increasingly higher-quality picture for video content delivered over the public Internet; and (c) some providers of video content over the public Internet stream, in a continuous fashion, traditional TV channels. Additionally, in the absence of universally-agreed-upon definitions, it is not unheard of for video content delivered over the public Internet to be referred to as IPTV. Furthermore, if the provider of the video content (over the public Internet) has a collaborative relationship with the user's ISP (e.g., if the ISP prioritizes packets from the provider of the video content), then the distinction is blurred further. However, for most, the fundamental difference between IPTV and Internet TV remains that IPTV entails delivering video content over a managed closed IP network, whereas Internet TV entails delivering video content over the public Internet. It is henceforth assumed that IPTV entails delivering video content over a managed closed IP network, whereas Internet TV entails delivering video content over the public Internet.

IP multicasting is a technique for one-to-many and many-to-many real-time communication over an IP network. It scales to a larger receiver population by not requiring prior knowledge of who the receivers are or how many receivers there are. IP multicasting uses network infrastructure efficiently by requiring the source to send a packet only once, even if it needs to be delivered to a large number of receivers. The nodes in the network (typically network switches and routers) take care of replicating the packet to reach multiple receivers with the goal that messages be sent over each link of the network only once.

IP multicasting, also known as multicasting, by its very nature, is not a connection-oriented mechanism. The most common transport-layer protocol to use multicast addressing is the User Datagram Protocol (UDP), a connectionless transport protocol. By its nature, UDP is not reliable, since UDP packets may be lost or delivered out of order. Another prominent transport-layer protocol is the Transmission Control Protocol (TCP), which is one of the core protocols of the Internet Protocol Suite. TCP provides reliable, ordered delivery of a stream of bytes from a program on one computer to another program on another computer. For example, TCP allows and has mechanisms for retransmission of missing packets. TCP is used by major Internet applications such as the World Wide Web, email, remote administration and file transfer. TCP is not natively well-suited for IP multicasting.

There are several mechanisms for delivering video content over IP networks. The suitability of a delivery mechanism can be a function of the type of video content. For example in the case of VOD, one delivery mechanism is for an end-user device (for example, the video-enabled device that will display the video) to download the video content in its entirety before starting to play it. The video content can, for example, be downloaded using HTTP. HTTP stands for Hypertext Transfer Protocol, and is a TCP-based application-layer protocol. HTTP is the foundation of data communication for the World Wide Web.

Another delivery mechanism for VOD is progressive download. Progressive download is a term used to describe the transfer of digital media files from a server to a client, typically using the HTTP protocol when initiated from an end-user device (e.g., a computer). The client-side application may begin playback of the media before the download is complete.

In the case of live video, typically video streaming technology is used, whereby video content is constantly received by and presented to an end-user while being delivered from a transmitting provider. When video streaming technology is used for live video, it is typical that: the video content is played immediately after a small amount of video data is received and buffered (for the purpose of reducing the likelihood of momentary blips in the video presentation); and the video content is not stored in the destination device.

It can be appreciated that any video streaming technology, including any video streaming technology for live video, can most likely also be used for VOD. When a video streaming technology, that does not normally store video content in the destination device, is used for VOD, it may be modified to allow storage of video content on the destination device.

The technology for streaming video over IP networks has evolved over time, and today there is a wide range of video streaming technologies that include older and newer technologies. Traditionally, streaming is typically delivered over UDP, a connectionless transport protocol in which packet losses result in poor quality of experience (QoE) and which has difficulty passing through certain firewalls. UDP-based delivery is well-suited for IP multicasting. The next step in the evolution of streaming video over IP networks came in the form of application-layer streaming protocols, including RTP, RTMP, and Adaptive HTTP Streaming. At the time of this writing there are at least three adaptive HTTP media streaming communications protocol in use: HTTP Live Streaming (HLS) implemented by Apple Inc. as part of their QuickTime X and iPhone software systems; HTTP Dynamic Streaming (HDS) implemented by Adobe Systems Inc; and Microsoft's Silverlight Smooth Streaming (MSS) implemented by Microsoft Inc. Clients may play the stream by requesting file segments in a profile from a Web server (also known as an HTTP server), downloading them via a sequence of HTTP GET requests. As the file segments are downloaded, the client plays back the file segments in the order requested. Adaptive delivery enables a client to “adapt” to fluctuating network conditions by selecting video file segments from different profiles. The client can easily compute the available network bandwidth. For example the client may compare the download time of a file segment with its size. If the client has a list of available profiles, it can determine if it needs to change to a lower bitrate/resolution profile or whether the available bandwidth allows it to download file segments from a higher bitrate/resolution profile. This list of available profiles is called a manifest or a playlist. The client's bandwidth calculation may be repeated at every file segment download, and so the client can adapt to changing network bandwidth or other conditions every few seconds. Aside from network bandwidth, conditions that may affect the client's choice of profile may include at least one of several factors. Examples of such factors include the following: the client's local CPU load; and the client's ability to play back a specific codec or resolution. A playlist/manifest file is provided to the client. The playlist/manifest lists the bitrates (and potentially other data) associated with the available stream profiles and the client uses it to determine how to download the file segments; that is, what URLs to use to fetch file segments corresponding to specific profiles. In the case of an on-demand source video request, the playlist/manifest contains information on every file segment in the content. In the case of live video, when the exact duration of the source video is typically not known a priori, this is generally not possible. HLS and HDS handle this case by delivering a ‘rolling window’ playlist/manifest data that contains references to the last available file segments. The client must update its playlist/manifest repeatedly in order to know about the most recently available file segments. MSS handles this case by delivering the information in each file segment that allows the client to access subsequent file segments, so no rolling window-type playlist/manifest is needed.

Emergency notifications are of interest to Cable TV Providers. Cable TV providers have a duty to display emergency alerts to their subscribers/viewers. Until recently this has been a relatively simply task, since subscribers were able to watch Cable TV only in their homes. When watching Cable TV in the home, the display of the alert is facilitated by the on-premises presence (i.e., presence in the subscribers' homes) of cable set-top boxes, which can be controlled by the Cable TV provider. Additionally, the Cable TV provider knows the locations of the subscribers' homes by virtue of having direct physical connections to them over the cable network. This knowledge enables the Cable TV provider to show emergency alerts only to subscribers in affected areas. With the advent of tablets and the availability of cellular wireless broadband connectivity, several Cable TV providers have enhanced or are in the process of enhancing their services to allow subscribers to watch Cable TV content on tablets (or other similar mobile devices) anywhere a subscriber goes, as long as they have data network connectivity. Cable TV content includes live television, TV programming and video-on-demand. Under this new delivery system however, the delivery of emergency alerts is more complicated than the delivery of emergency alerts to subscribers watching Cable TV in their homes.

The term emergency event will henceforth refer to an incident, an event, a threat, a hazard and/or any trigger that may result in the transmission of an emergency alert.

### Delivering Emergency Alerts to Video Applications Over an IP Network

The techniques described below facilitate the delivery of emergency alerts, to viewers receiving the video data, from a provider of video content, over an IP network, including: the case of an end-user receiving video content over a managed closed IP network; and the case of an end-user receiving video content over the Internet.

There are four approaches for the invention. Henceforth, the term provider of video content includes the possibility of a content delivery network physically providing the all or part of the video content on behalf of the origin provider/server.

The application on the video-enabled device, which displays/plays/renders the video content, will henceforth be referred to as the client application. The client application may be a single software program. The client application may be multiple cooperating software programs. The said video-enabled device will henceforth be referred to as the client device. The video content originally requested by the client application will henceforth referred to as source video content.

In Approach 1, Approach 2 and Approach 4, the client application may display/render an emergency alert to viewers in at least one of several forms. Examples of such forms include: crawling text within the source video content; an alert tone; an audio alert (similar to alert tone except that the tone is substituted with one or more spoken words); an overlay display; vibration of client device; vibration cadence; an alert audio, which is audio content containing pre-recorded and/or live content related to the emergency event; and an alert video, which is video content containing pre-recorded and/or live content related to the emergency event.

In Approach 1, Approach 2 and Approach 4: the client application may display/render one or more emergency alerts to a viewer; the client application may display/render an emergency alert to a viewer one ore more times; an emergency alert may be customized/personalized based on data/parameters related to the viewer and/or the client device; the decision regarding whether to display/render an emergency alert may be based on data/parameters related to the viewer and/or the client device; and the display/rendering of an emergency alert may entail prompting and/or making available the ability to a viewer to take an action to receive additional information related to the emergency alert. The said action may take at least one of several forms. Examples of such forms include: clicking on a button; clicking on a link; and voice activation.

### Basic Method of Approach 1 for the Invention

This section describes the basic method of Approach 1 for the Invention. Approach 1 may also be realized using at least one of several variations on the basic method of Approach 1. Examples of such variations include the ones described later. It can be appreciated that any combination of the variations constitutes a variation on the basic method described in this section.

In the basic method of Approach 1, the provider of video content (e.g., a Cable TV provider) may transmit information related to the emergency alert (henceforth referred to as alert information) using at least one of several methods. Examples of such methods include:

1. The alert information may be placed/embedded in the playlist/manifest files and/or the video file segments associated with the source video content. The alert information may be in at least one of several forms. Examples of such forms include the following: comments; and metadata.

2. The alert information may be placed/embedded in the header data of one or more HTTP response messages carrying playlist/manifest files and/or video file segments associated with the source video content.

3. The alert information may be placed/embedded in the main data stream carrying the source video content in such a way that the client application may recognize that the data associated with the alert information is not associated with the source video content.

4. The alert information may be transmitted to the client application using a different communication channel/connection than the one used to transmit video content.

Embedded alert information need not impact the ability of the client application to display/play/render the source video content.

The provider of video content may perform preliminary geo-targeting by transmitting alert information to client devices that are possibly within the alert area but are not guaranteed to be within the said area.

The client application is designed to look for the alert information. Upon receiving the alert information, the client application will issue a “should-display?” request to a specified server, which will henceforth be referred to as the decision server. The decision server may be an origin server associated with the provider of video content. It may also be a server within a CDN. The decision server may use at least one of several types of information in the said “should-display?” request to make a determination regarding whether or not the client application should display/render the emergency alert. Examples of such types of information in the said “should-display?” request include the following: routing information and the client device's IP address. The decision server may base the said determination on at least one of several factors. Examples of such factors include: the geographic location of the client device; and one or more estimates of the geographic location of the client device.

The decision server sends the said determination to the client application. The client application either displays/renders the emergency alert or does not based on the determination it receives from the decision server. The client application may have the option of overriding a determination received from a decision server.

The “should-display?” request may be in the form of and/or may use elements of one or more existing communication or data network protocols. The “should-display?” request may consist of a set of request messages. The decision server may consist of several physical servers, whereby the “should-display?” request may be sent to one or more servers. If the “should-display?” request consists of more than one request message and is sent to multiple servers, then different subsets of the request messages may be sent to different servers. Sending the “should-display?” request to multiple servers may facilitate the process of calculating an estimate of the location of the client device.

The “should-display?” request may include at least one of several types of information related to the client device's location. Examples of such types of information include the following: one or more estimates for the client device's location, an example of which is a GPS-enabled estimate; and network-related information about the client device's network neighbors including the IP address of its network gateway.

The “should-display?” request may be modified by the client device's ISP or an INE. The response to the “should-display?” request may be modified by the client device's ISP or an INE. The response to the “should-display?” request may be provided by the client device's ISP or an INE on behalf of the decision server.

The provider of video content may transmit multiple sets of alert information associated with multiple emergency alerts whereby the client application may display/render any number of the said multiple emergency alerts including none.

The client application may transmit a message that contains at least one of several types of information. Examples of such types of information include the following: whether or not it displayed/rendered an emergency alert; and the reasoning behind the decision of displaying/rendering or not displaying/rendering the emergency alert.

### Variations of Approach 1 for the Invention

As previously mentioned, Approach 1 may be realized using at least one of several variations on the basic method. Examples of such variations include:

Variation 1: In this variation, the alert information comprises a call for showing the emergency alert message. Upon receiving an affirmative “should-display?” response, the client application may request video file segments associated with the alert video (and/or possibly one or more playlist/manifest files). Video file segments associated with an alert video will henceforth be referred to as alert video file segments. A list of alert video file segments (and/or possibly one or more playlist/manifest files and/or possibly a list of playlist/manifest files) may be included partially or wholly in at least one of the original embedded alert information and the “should-display?” response. Alert video file segments (and/or possibly playlist/manifest files) may be served from an origin server or from a CDN. Some of the data in a list of alert video file segments (and/or possibly one or more playlist/manifest files and/or possibly a list of playlist/manifest files) may be pre-stored on the client device. Some of the data in the alert video may be pre-stored on the client device.

Variation 2: The emergency alert to be displayed/rendered may be contained, in part or in whole, in the original embedded alert information. Upon receiving an affirmative “should-display?” response, the client application may construct the emergency alert from at least one of several sources. Examples of such sources include: the original embedded alert information; information contained in the “should-display?” response; information received by the client application subsequent to the “should-display?” response; information received by the client application from sources other than the provider of video content; and information pre-stored on the client device.

Variation 3: Alert video file segments (and/or possibly one or more playlist/manifest files) may be contained in the source video content data received by the client application. The said alert video file segments may contain a portion or all of the alert video. Upon receiving an affirmative “should-display?” response, the client application may procure additional information using at least one of several methods. Examples of such methods include: requesting additional alert video file segments; retrieving additional information contained in the “should-display?” response; retrieving additional information received by the client application subsequent to the “should-display?” response; retrieving additional information received by the client from sources other than the provider of video content; and retrieving additional information pre-stored on the client device.

The client application and may render/display the emergency alert using content included in at least one of the alert video file segments and the additional information. Otherwise, the client application may ignore any alert video file segments and any additional information; and continue to display/play the “regular program” i.e., the source video content.

Variation 4: The alert information may contain a geographic description of the alert area, and the client application may use the geographic description to determine whether on not to display/render the emergency alert, without needing to send a “should-display?” request. The client application's determination may be based on its estimation of the client device's location. The said estimation may be based on at least one of several methods/sources. Examples of such methods/sources include the following: the client device's GPS receiver; network-based triangulation techniques; handset-based triangulation techniques; information provided by the provider of video content; one or more estimates from one or more providers of a service that estimates the location of a device connected to an IP network, including the Internet; and information provided by the client device's ISP or an INE. The said information may be provided using at least one of several methods. Examples of such methods include: placing/embedding the said information in the alert information; and the said information being requested by the client application.

Variation 5: Upon receiving the alert information, the client application may make the determination of whether or not to display/render the emergency alert based on general information, without needing to send a “should-display?” request. The said general information may be obtained using/from at least one of several methods/sources. Examples of such methods/sources include the following: general information included in the alert information; general information included in the response to the “should-display?” request; general information requested by the client device, possibly in response to the alert information; networking information including the client device's IP address, the IP address of its network gateway, and the IP address of a CDN server; whether any of the client device's network neighbors display/render the emergency alert; general information provided by the provider of video content; general information provided by the client device's ISP or an INE; and general information received separately by the client device including: a CMAS (Commercial Mobile Alert System) alert; a general cellular broadcast message; an MBMS (cellular Multimedia Broadcast Multicast Services) alert message; a general MBMS broadcast message; an M-EAS (Mobile Emergency Alert System) emergency alert message delivered via mobile digital TV broadcasting; a general mobile digital TV broadcast message; a NOAA Weather Radio All Hazards emergency alert message; a TV/Radio broadcast emergency alert message; a general TV/Radio broadcast message; and; a message communicated to the client device from an information provider. The said information provider may communicate a message to the client device using at least one of several communication means. Examples of such communication means include: using a wireless communication means; communicating information over the Internet.

Making the determination based on general information may make it unnecessary for the client application to send a “should-display?” request.

Variation 6: The client device's ISP or an INE may use its one or more estimates of the geo-location of the client device, and place/embed the said information and/or information related to it and/or an ISP/INE's estimate/suggestion for the decision server's determination in the “should-display?” request.

Variation 7: The client device's ISP or an INE may use its one or more estimates of the geo-location of the client device, and place/embed the said information and/or information related to it and/or an ISP/INE's estimate/suggestion for the decision server's determination in the response to the “should-display?” request.

Variation 8: The client device's ISP or an INE may use its one or more estimates of the geo-location of the client device, and place/embed, in the alert information, a determination of whether the client application should display/render the emergency alert associated with the alert information, possibly making it unnecessary for the client application to send a “should-display?” request.

Variation 9: The client device's ISP may communicate to the client device a determination of whether the client application should display/render the emergency alert associated with the alert information, possibly making it unnecessary for the client application to send a “should-display?” request. The said communication may be in at least one of several forms. Examples of such forms include the following:

a network broadcast by the ISP; and

a request containing the said determination to the client device.

Variation 10: The provider of video content may place/embed, in the alert information, the determination of whether the client application should display/render the emergency alert associated with the alert information, possibly making it unnecessary for the client application to send a “should-display?” request. One method for placing the determination is the mere existence/receipt of the alert information. The provider of video content may make its determination based on at least one of several methods/sources. Examples of such methods/sources include the following:

the client device's ISP or an INE communicating its one or more estimates of the geo-location of the client device to the provider of video content;

general networking information including routing information and the client device's IP address; and

the client device communicating one or more estimates of its geo-location, an example of which is a GPS-enabled estimate, to the provider of video content.

It can be appreciated that any combination of the variations in Section 12.2 constitutes a variation on the basic method described in this section.

### Approach 2 for the Invention

In Approach 2, the client application may receive information related to an emergency alert from one or more sources other than the provider of video content. The said information may be received in at least one of several forms. Examples of such forms include: a CMAS alert message; a general cellular broadcast message; an MBMS alert message; a general MBMS broadcast message; an M-EAS emergency alert message delivered via mobile digital TV broadcasting; a general mobile digital TV broadcast message; a NOAA Weather Radio All Hazards emergency alert message; a TV/Radio broadcast emergency alert message; a general TV/Radio broadcast message; a message communicated to the client device from the ISP providing it with access to the Internet; a message communicated to the client device from an information provider over the Internet; a message communicated to the client device from one or more of its network neighbors; and a message communicated to the client device from an information provider using a wireless communication means.

The reception of the said information may be indicative that the client device is in an alert area.

Upon receiving the information related to the emergency alert, the client application may display/render the emergency alert and create it based on at least one of several processing methods. Examples of such processing methods include the following: creating the emergency alert using the received information as is; creating the emergency alert based on the received information; and using its network connectivity to request additional information and creating the emergency alert based on at least one of the originally received information and the additionally requested information.

The client application may receive multiple sets of information related to multiple emergency alerts whereby the client application may display/render any number of the said multiple emergency alerts including none.

The client application may transmit a message that contains at least one of several types of information. Examples of such types of information include the following: whether or not it displayed/rendered an emergency alert; and the reasoning behind the decision of displaying/rendering or not displaying/rendering the emergency alert.

### Approach 3 for the Invention

The provider of video content may be aware that the client device running/hosting the client application may receive an emergency alert about an emergency event via at least one of several other separate methods. Examples of such separate methods include: a CMAS alert message; a general cellular broadcast message; an MBMS alert message; a general MBMS broadcast message; an M-EAS emergency alert message delivered via mobile digital TV broadcasting; a general mobile digital TV broadcast message; a NOAA Weather Radio All Hazards emergency alert message; a TV/Radio broadcast emergency alert message; a general TV/Radio broadcast message; a message communicated to the client device from the ISP providing it with access to the Internet; a message communicated to the client device from an information provider over the Internet; a message communicated to the client device from one or more of its network neighbors; and a message communicated to the client device from an information provider using a wireless communication means.

Given the said awareness the provider of video content may elect to not transmit alert information to the client application, and rely on one or more other separate methods for the user of the client device to receive an emergency alert.

### Approach 4 for the Invention

In adaptive HTTP streaming, the client application makes several HTTP requests to the provider of video content for video file segments. In Approach 4, the client device's ISP and/or an INE may assume the role of a proxy server. In the role of a proxy server, the ISP or an INE may fulfill at least one HTTP request from the client application, on behalf of the provider of video content. An HTTP request may be fulfilled by the ISP or an INE, in the role of a proxy server, via an HTTP response containing at least one of several types of data. Examples of such types of data include:
one or more alert video file segments;
one or more alert audio files;
alert information;
instructions to the client application; and
one or more estimates of the client devices geographic location.

The ISP or an INE may base its decision, regarding whether or not to assume the role of a proxy server, on a determination regarding whether client device is located in an alert area.

The ISP or an INE may accelerate an HTTP request by the client application by tearing down or causing the tearing down of an existing communication session between the client application and the provider of video content.

The ISP or an INE may serve multiple sets of data associated with multiple emergency alerts whereby the client application may display/render any number of the said multiple emergency alerts including none.

The client application may transmit a message that contains at least one of several types of information. Examples of such types of information include the following:
whether or not it displayed/rendered an emergency alert; and
the reasoning behind the decision of displaying/rendering or not displaying/rendering the emergency alert.

### Combination of Approach 1, Approach 2, Approach 3, and Approach 4

It can be appreciated that some or all elements of Approach 1, Approach 2, Approach 3 and Approach 4 may be combined to facilitate the delivery of emergency alerts to viewers receiving video data from a provider of video content, over an IP network.

### Generality of the Invention

The invention may be used by any provider of video content over an IP network, including IPTV providers, Cable TV providers, and Internet TV providers.

Certain elements/aspects of the invention may be applicable to streaming formats/protocols other than adaptive HTTP streaming.

All elements/aspects of the invention are applicable to the case of the video content being delivered using IP unicasting. Certain elements/aspects of the invention may be applicable to the case of the video content being delivered using IP multicasting.

### Extensibility of Approach 1

It can be appreciated that methods described for communicating emergency alerts in Approach 1 can be extended to be used by any pair of (1) a provider of content and (2) a client application receiving content from the said provider of content over an IP network.

For example, Approach 1 may be extended to be used by a provider of audio content, in which case:
The provider of audio content may transmit alert audio file segments in order to render the emergency alert in the form of an alert audio.
The client application may be designed to primarily play audio content but may also have the capability to display video alerts.

It can also be appreciated that methods described for communicating emergency alerts in Approach 1, and any extensions thereof, can be extended to be used for communicating other forms of information and/or instructions.

In particular, Approach 1 methods may be extended to advertising; whereby one or more advertisements may be presented to an end-user/viewer.

In the case of extending Approach 1 methods to advertising, the description may be modified as follows to make it more applicable to advertising:
The term “emergency alert” may be substituted with the term “advertisement”.
The term “alert area” may be substituted with the term “advertisement area”, whereby advertisement area refers to the geographic area to which the advertisement is targeted.
The term “alert information” may be substituted with the term “advertisement information”, whereby advertisement information refers to information related to the advertisement.
The term “emergency alert message” may be substituted with the term “advertisement message”.
The term “alert audio” may be substituted with the term “advertisement audio”.
The term “alert video” may be substituted with the term “advertisement video”.
The term “emergency event” may be substituted with the term “advertised product”, whereby advertised product refers to the object of the advertisement such as a product, a service, an event, a TV event, a TV program, a campaign message, a public service announcement, or a request for help.
The following methods for rendering/displaying an advertisement may be unlikely to be used: an audio alert; an alert tone; vibration of client device; and vibration cadence.
The following forms of information may be unlikely to be used: a CMAS alert message; an MBMS alert message; an M-EAS emergency alert message delivered via mobile digital TV broadcasting; a NOAA Weather Radio All Hazards emergency alert message; and a TV/Radio broadcast emergency alert message.

### Extensibility of Approach 2

It can be appreciated that methods described for communicating emergency alerts in Approach 2 can be extended to be used by any pair of (1) a provider of content and (2) a client application receiving content from the said provider of content over an IP network.

For example, Approach 2 may be extended to be used by a provider of audio content, in which case:
The client application may be designed to primarily play audio content but may also have the capability to display video alerts

It can be appreciated that methods described for communicating emergency alerts in Approach 2, and any an extensions thereof, can be extended to be used for communicating other forms of information and/or instructions.

In particular, Approach 2 methods may be extended to advertising; whereby one or more advertisements may be presented to an end-user/viewer.

In the case of extending Approach 2 methods to advertising, the description in Section 12.3 may be modified as follows to make it more applicable to advertising:
The term “emergency alert” may be substituted with the term “advertisement”.
The term “alert area” may be substituted with the term “advertisement area”, whereby advertisement area refers to the geographic area to which the advertisement is targeted.
The term “emergency alert message” may be substituted with the term “advertisement message”.
The term “alert audio” may be substituted with the term “advertisement audio”.
The term “alert video” may be substituted with the term “advertisement video”.
The term “emergency event” may be substituted with the term “advertised product”, whereby advertised product refers to the object of the advertisement such as a product, a service, an event, a TV event, a TV program, a campaign message, a public service announcement, or a request for help.
The following methods for rendering/displaying an advertisement may be unlikely to be used: an audio alert; an alert tone; vibration of client device; and vibration cadence.
The following forms of information may be unlikely to be used:
   a CMAS alert message;
   an MBMS alert message;
   an M-EAS emergency alert message delivered via mobile digital TV broadcasting;
   a NOAA Weather Radio All Hazards emergency alert message; and
   a TV/Radio broadcast emergency alert message.

### Extensibility of Approach 3

It can be appreciated that methods described for communicating emergency alerts in Approach 3 can be extended to be used by any pair of (1) a provider of content and (2) a client application receiving content from the said provider of content over an IP network.

It can be appreciated that methods described for communicating emergency alerts in Approach 3 can be extended to any device that:
may display/render alerts to its users; and
may receive an emergency alert about an emergency event via at least one of several methods. Examples of such separate methods include:
a CMAS alert message,
a general cellular broadcast message,
an MBMS alert message,
a general MBMS broadcast message,
an M-EAS emergency alert message delivered via mobile digital TV broadcasting,
a general mobile digital TV broadcast message,
a NOAA Weather Radio All Hazards emergency alert message,
a TV/Radio broadcast emergency alert message,
a general TV/Radio broadcast message,
a message communicated to the client device from the ISP providing it with access to the Internet,
a message communicated to the client device from an information provider over the Internet,
a message communicated to the client device from one or more of its network neighbors, and
a message communicated to the client device from an information provider using a wireless communication means.

Such a device need not be running a client application receiving content over an IP network or running a client application.

The users of the said device include:
individuals using the device;
individuals operating the device;
individuals receiving communication from the device; and
other devices/machines receiving communication from the device.

Upon receiving an emergency alert about an emergency event the said device may display/render an alert to its user or users.

The said device may be equipped with at least one of several receivers. Examples of such receivers include:
a cellular receiver;
a mobile digital TV receiver;
a NOAA Weather Radio All Hazards receiver;
a software module/component/application designed to receive certain information over the Internet;
a firmware module/component designed to receive certain information over the Internet; and
a hardware module/component designed to receive certain information over the Internet.

Examples of the said device include:
an outdoor siren equipped with a cellular receiver; and
a visual display in a public space equipped with a cellular receiver.

It can be appreciated that methods described for communicating emergency alerts in Approach 3, and any extensions thereof, can be extended to be used for communicating other forms of information and/or instructions; whereby a provider of content is aware of a separate application or set of applications available on the client device for the purpose of delivering/rendering the said other forms of information and/or instructions.

In particular, Approach 3 methods may be extended to advertising; whereby one or more advertisements may be presented to an end-user/viewer.

In the case of extending Approach 3 methods to advertising, the description may be modified as follows to make it more applicable to advertising:
The term “emergency alert” may be substituted with the term “advertisement”.
The term “emergency alert message” may be substituted with the term “advertisement message”.
The term “emergency event” may be substituted with the term “advertised product”, whereby advertised product refers to the object of the advertisement such as a product, a service, an event, a TV event, a TV program, a campaign message, a public service announcement, or a request for help.
The following forms of information may be unlikely to be used:
a CMAS alert message;
an MBMS alert message;
an M-EAS emergency alert message delivered via mobile digital TV broadcasting;
a NOAA Weather Radio All Hazards emergency alert message; and
a TV/Radio broadcast emergency alert message.

### Extensibility of Approach 4

It can be appreciated that methods described for communicating emergency alerts in Approach 4 can be extended to be used by any pair of (1) a provider of content and (2) a client application receiving content from the said provider of content over an IP network.

For example, Approach 4 may be extended to be used by a provider of audio content, in which case:
The ISP or an INE may transmit alert audio file segments in order to render the emergency alert in the form of an alert audio.
The client application may be designed to primarily play audio content but may also have the capability to display video alerts

It can be appreciated that methods described for communicating emergency alerts in Approach 4, and any an extensions thereof, can be extended to be used for communicating other forms of information and/or instructions.

In particular, Approach 4 methods may be extended to advertising; whereby one or more advertisements may be presented to an end-user/viewer.

In the case of extending Approach 4 methods to advertising, the description may be modified as follows to make it more applicable to advertising:
The term “emergency alert” may be substituted with the term “advertisement”.
The term “alert area” may be substituted with the term “advertisement area”, whereby advertisement area refers to the geographic area to which the advertisement is targeted.
The term “alert information” may be substituted with the term “advertisement information”, whereby advertisement information refers to information related to the advertisement.
The term “emergency alert message” may be substituted with the term “advertisement message”.
The term “alert audio” may be substituted with the term “advertisement audio”.
The term “alert video” may be substituted with the term “advertisement video”.
The term “emergency event” may be substituted with the term “advertised product”, whereby advertised product refers to the object of the advertisement such as a product, a service, an event, a TV event, a TV program, a campaign message, a public service announcement, or a request for help.
The following methods for rendering/displaying an advertisement may be unlikely to be used:
an audio alert;
an alert tone;
vibration of client device; and
vibration cadence.

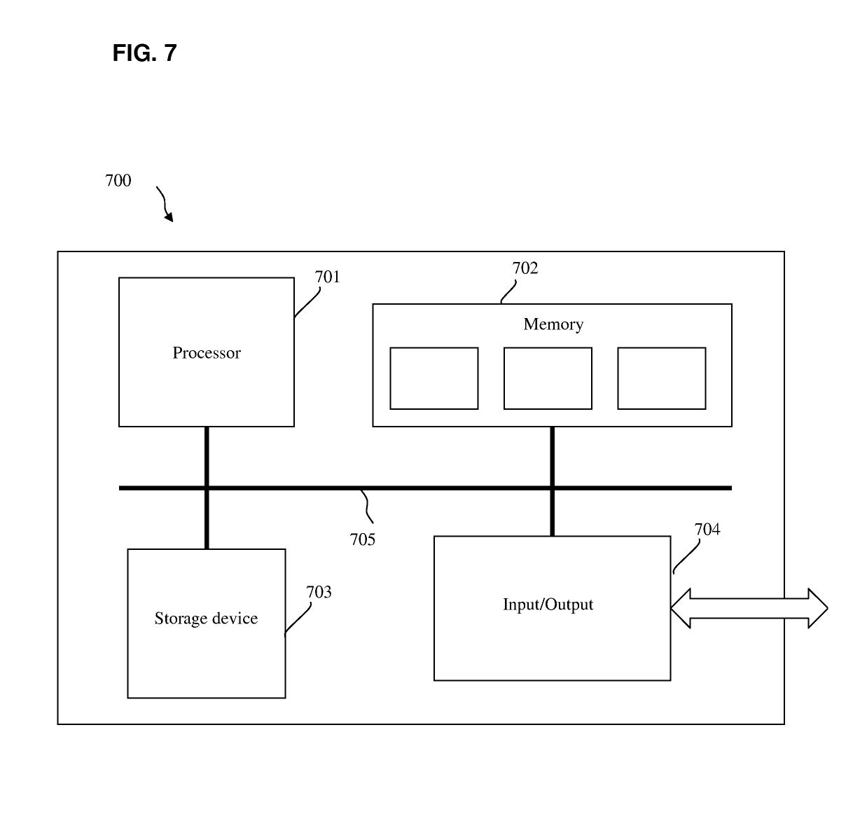

FIG. 7 is a block diagram of an example computer system 70. For example, referring to FIG. 2, the client 201, the server 202, and the first order proxy server 204 could be an example of the system 70 described here, as could a computer system used by any of the users who access resources of the system in FIG. 2. The system 70 includes a processor 71, a memory 72, a storage device 73, and an input/output device 74. Each of the components 71, 72, 73, and 74 can be interconnected, for example, using a system bus 75. The processor 71 is capable of processing instructions for execution within the system 70. In some implementations, the processor 71 is a single-threaded processor. In some implementations, the processor 71 is a multi-threaded processor. In some implementations, the processor 71 is a quantum computer. The processor 71 is capable of processing instructions stored in the memory 72 or on the storage device 73. The processor 71 may execute operations such as re-encoding 507 and/or reverse re-encoding 508 (FIG. 5).

The memory 72 stores information within the system 70. In some implementations, the memory 72 is a computer-readable medium. In some implementations, the memory 72 is a volatile memory unit. In some implementations, the memory 72 is a non-volatile memory unit.

The storage device 73 is capable of providing mass storage for the system 70. In some implementations, the storage device 73 is a computer-readable medium. In various different implementations, the storage device 73 can include, for example, a hard disk device, an optical disk device, a solid-date drive, a flash drive, magnetic tape, or some other large capacity storage device. In some implementations, the storage device 73 may be a cloud storage device, e.g., a logical storage device including multiple physical storage devices distributed on a network and accessed using a network. The input/output device 74 provides input/output operations for the system 70. In some implementations, the input/output device 74 can include one or more of a network interface devices, e.g., an Ethernet card, a serial communication device, e.g., an RS-232 port, and/or a wireless interface device, e.g., an 802.11 card, a 3G wireless modem, a 4G wireless modem, or a carrier pigeon interface. A network interface device allows the system 70 to communicate, for example, transmit and receive data such as messages. In some implementations, the input/output device can include driver devices configured to receive input data and send output data to other input/output devices, e.g., keyboard, printer and display devices. In some implementations, mobile computing devices, mobile communication devices, and other devices can be used.

A computer system 70 can be realized by instructions that upon execution cause one or more processing devices to carry out the processes and functions described above, for example, the steps shown in FIG. 3. Such instructions can comprise, for example, interpreted instructions such as script instructions, or executable code, or other instructions stored in a computer readable medium. A computer system 70 can be distributively implemented over a network, such as a server farm, or a set of widely distributed servers or can be implemented in a single virtual device that includes multiple distributed devices that operate in coordination with one another. For example, one of the devices can control the other devices, or the devices may operate under a set of coordinated rules or protocols, or the devices may be coordinated in another fashion. The coordinated operation of the multiple distributed devices presents the appearance of operating as a single device.

Although an example processing system has been described in FIG. 7, implementations of the subject matter and the functional operations described above can be implemented in other types of digital electronic circuitry, or in computer software, firmware, or hardware, including the structures disclosed in this specification and their structural equivalents, or in combinations of one or more of them. Implementations of the subject matter described in this specification, such as software for re-encoding and reverse re-encoding (e.g., FIG. 5), can be implemented as one or more computer program products, i.e., one or more modules of computer program instructions encoded on a tangible program carrier, for example a computer-readable medium, for execution by, or to control the operation of, a processing system. The computer readable medium can be a machine readable storage device, a machine readable storage substrate, a memory device, a composition of matter effecting a machine readable propagated signal, or a combination of one or more of them.

The term “system” may encompass all apparatus, devices, and machines for processing data, including by way of example a programmable processor, a computer, or multiple processors or computers. A processing system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, executable logic, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Computer readable media suitable for storing computer program instructions and data include all forms of non-volatile or volatile memory, media and memory devices, including by way of example semiconductor memory devices, e.g., EPROM, EEPROM, and flash memory devices; magnetic disks, e.g., internal hard disks or removable disks or magnetic tapes; magneto optical disks; and CD-ROM and DVD-ROM disks. The processor and the memory can be supplemented by, or incorporated in, special purpose logic circuitry. Sometimes a server (e.g., forming a portion of a communications facility 100) is a general purpose computer, and sometimes it is a custom-tailored special purpose electronic device, and sometimes it is a combination of these things.

Implementations can include a back end component, e.g., a data server, or a middleware component, e.g., an application server, or a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

Certain features that are described above in the context of separate implementations can also be implemented in combination in a single implementation. Conversely, features that are described in the context of a single implementation can be implemented in multiple implementations separately or in any sub-combinations.

The order in which operations are performed as described above can be altered. In certain circumstances, multitasking and parallel processing may be advantageous. The separation of system components in the implementations described above should not be understood as requiring such separation.

What has been described above includes examples of some possible implementations. It is, of course, not possible to describe every conceivable combination of components or methodologies, but one of ordinary skill in the art may recognize that many further combinations and permutations are possible. Accordingly, the invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. An apparatus for enabling electronic devices to receive MNMs.

2. A technique for enhancing MNMs.

3. An apparatus for enabling personal electronic devices to render emergency alerts based on received WEA messages.

4. Techniques for delivering geo-targeted alerts to video applications downloading video over IP networks.
